(19) United States
(12) Patent Application Publication
(10) Pub. No.: US 2023/0353995 A1
(43) Pub. Date: Nov. 2, 2023

(54) TECHNIQUES FOR INITIATING DATA SESSIONS IN SIDELINK COMMUNICATIONS

(71) Applicant: QUALCOMM Incorporated, San Diego, CA (US)

(72) Inventors: Aasif S.A. DINGANKAR, San Diego, CA (US); Rashmin ANJARIA, San Diego, CA (US); Lan TRAN, San Diego, CA (US)

(21) Appl. No.: 17/733,651

(22) Filed: Apr. 29, 2022

(51) Int. Cl. H04W 4/44; H04W 24/10; H04L 1/00

(52) U.S. Cl. CPC H04W 4/44; H04W 24/10; H04L 1/0003

(57) ABSTRACT

Some aspects described herein relate to vehicle-based wireless communications, including receiving a wave service announcement (WSA) from a roadside unit (RSU), and initiating, with the RSU, a data session based on a signal measurement of the WSA. Other aspects relate to transmitting the WSA, receiving the data session initiation or corresponding request, and transmitting data based on a modulation and coding scheme (MCS) or bandwidth associated with the request.

### BACKGROUND

Aspects of the present disclosure relate generally to sidelink wireless communication systems, and more particularly, to sidelink communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable low-latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in 5G communications technology and beyond may be desired.

In some wireless communication technologies, such as 5G, user equipment (UEs) communicate over one or more of multiple interfaces. The multiple interfaces may include a Uu interface between the UE and a base station, where the UE can receive communications from the base station over a downlink and transmit communications to the base station over an uplink. In addition, the multiple interfaces may include a sidelink interface to communicate with one or more other UEs directly over a sidelink channel (e.g., without traversing the base station).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, a memory configured to store instructions, and one or more processors communicatively coupled with the memory and the transceiver. The one or more processors are configured to receive a wave service announcement (WSA) from a roadside unit (RSU), and initiate, with the RSU, a transmission control protocol/internet protocol (TCP/IP) session based on a signal measurement of the WSA.

In another aspect, a method for wireless communication is provided that includes receiving a WSA from a RSU, and initiating, with the RSU, a TCP/IP session based on a signal measurement of the WSA.

In another aspect, an apparatus for wireless communication is provided that includes a transceiver, a memory configured to store instructions, and one or more processors communicatively coupled with the transceiver and the memory. The one or more processors are configured to transmit a WSA, receive a request to initiate a data session based on a signal measurement of the WSA, and transmit downlink data in the data session based on a modulation and coding scheme (MCS) and bandwidth associated with the request.

In another aspect, a method for wireless communication is provided that includes transmitting a WSA, receiving a request to initiate a data session based on a signal measurement of the WSA, and transmitting downlink data in the data session based on a MCS and bandwidth associated with the request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a user equipment (UE), in accordance with various aspects of the present disclosure;

FIG. 3 is a flow chart illustrating an example of a method for initiating a data session, in accordance with various aspects of the present disclosure;

FIG. 4 is a flow chart illustrating an example of a method for communicating with in sidelink (SL) based on changing modulation and coding scheme (MCS) or bandwidth, in accordance with various aspects of the present disclosure; and

FIG. 5 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to initiating data sessions (e.g., transmission control protocol (TCP)/Internet protocol (IP) sessions) in sidelink (SL) communications. For example, SL communications can refer to device-to-device (D2D) communication among devices (e.g., user equipment (UEs)) in a wireless network. In a specific example, SL communications can be defined for vehicle-based communications, such as vehicle-to-vehicle (V2V) communications between two vehicle-based communication device that are on a vehicle (e.g., onboard units (OBUs) or vehicle-to-infrastructure (V2I) communications (e.g., from a vehicle-based communication device, such as a OBU, to a road infrastructure node (e.g., roadside unit (RSU)) or a combination thereof and/or with other devices. In addition, some vehicle-based communications can also include communications that are not over SL, such as the vehicle-to-network (V2N) communications (e.g., from a vehicle-based communication device to one or more network nodes, such as a base station). These communications can be collectively referred to as vehicle-to-anything (V2X) communications. In another example, V2X communications can include communications to or from vulnerable road uses (VRUs), such as users on bicycles, scooters, or other modes of transportation that may use a cellular phone or other personal device for V2X communications. In some SL V2X communications, OBUs can communicate with one another and/or with RSUs over a SL channel.

V2X communications can occur over one or more slots. A slot can be defined in a wireless communication technology (e.g., third generation partnership project (3GPP) long term evolution (LTE) or fifth generation (5G) new radio (NR), etc.) as including a collection of multiple symbols, where the multiple symbols can be one of orthogonal frequency division multiplexing (OFDM) symbols, single carrier-frequency division multiplexing (SC-FDM) symbols, or other types of symbols. In an example, the number of symbols in a slot may vary based on a cyclic prefix (CP) length defined for the symbols.

In LTE V2X or other vehicle-based communications, for example, RSUs can offer certain services to OBUs, such as IPv6 services. In an example, such IPv6 services may include services related to security credential management services (SCMS), such as certificate revocation list (CRL) download, certificate top-offs, etc., probe data upload, such as upload of requested characteristics for a selected population of vehicles, and/or the like. RSUs can periodically transmit wave service announcements (WSAs) and/or wave router announcements (WRAs) to advertise such services, and OBUs can discover these services by receiving and processing the WSAs and/or WRAs from the RSUs. Based on the WSAs/WRAs, an OBU can initiate an IPv6 session with the RSU based on a subnet advertised in the WRA, and the RSU can forward traffic from the OBU to the appropriate destination to provide the advertised service to the OBU.

Specifically, for example, LTE V2X can operate in a 20 megahertz (MHz) channel, which can include 100 resource blocks (RBs). WSAs/WRAs can be relatively small in size (e.g., 200-300 bytes). LTE V2X can adapt transmission parameters based on packet size, and as such a 200-300 byte packet can typically be transmitted using a modulation and coding scheme (MCS) 6 and 20 RBs (2 control channel (CC)+18). IP applications usually try to send full buffer traffic, which can result in packets of 1500 bytes. A 1500 byte packet can typically be transmitted using MCS 11, 96RB (96 data channel). Coverage of MCS 6, 20 RB is larger than coverage of MCS 11, 98 RB transmission. For example, this can yield a 7.27 decibel (dB) delta based on bandwidth (e.g., 10 log 10(96)−10 log 10(18)). Signal-to-noise ratio (SNR) delta between MCS 6 and MCS 11 can be around 4 dB, which can result in a total delta of around 11 dB.

OBUs can move throughout a geographic area, and as such, communication quality with a static unit, such as a RSU (or another mobile unit, such as another OBU) can vary over time. In an example, if the OBU tries to establish a data session, such as a IPv6 session or other IP or non-IP bidirectional traffic or data session, too early based on received WSA (e.g., when the OBU first discovers the RSU and WSA or WRA), the session can be established with the RSU, as SYN, ACK packets are small. When the applications try to pass data via the RSU, however, the larger data packets may fail. Further if TCP is chosen as the transport protocol, a TCP session can end up in exponential backoff when it tries to pass data and fails. Additionally, SL bandwidth is shared between safety messages and non-safety messages including the IP based, or non-IP bidirectional based, applications. These applications can be limited in amount of data they can send to avoid impact to safety messages and to limit transmit duty cycle as the system can be half-duplex. In some examples, traffic for these applications can be limited to transmitting on four percent of available subframes in a 10 second period, which can cause TCP based traffic to be limited and can cause variable delays if TCP is trying to maximize throughput and the four percent limit is reached.

Accordingly, aspects described herein relate to initiating data sessions between UEs at desirable times or distances between the UE to improve use of the data session. In one aspect, a first UE (e.g., a OBU) can initiate a data session with a second UE (e.g., a RSU) in SL communications (e.g., V2X) based on a signal measurement of the WSA. For example, the first UE can initiate the data session with the second UE where the signal measurement achieves a threshold, or may otherwise refrain from initiating the data session. In another aspect, the first UE can initiate the data session and then can adapt the MCS once the data session is initiated to use a higher MCS as the signal measurement improves. The aspects described herein can allow for UEs to initiate data sessions when the radio frequency (RF) environment can support desirable data session transfer rates. This can facilitate improved data session uptime, which can improve quality of communications and communication throughput for the devices, which can improve user experience, etc.

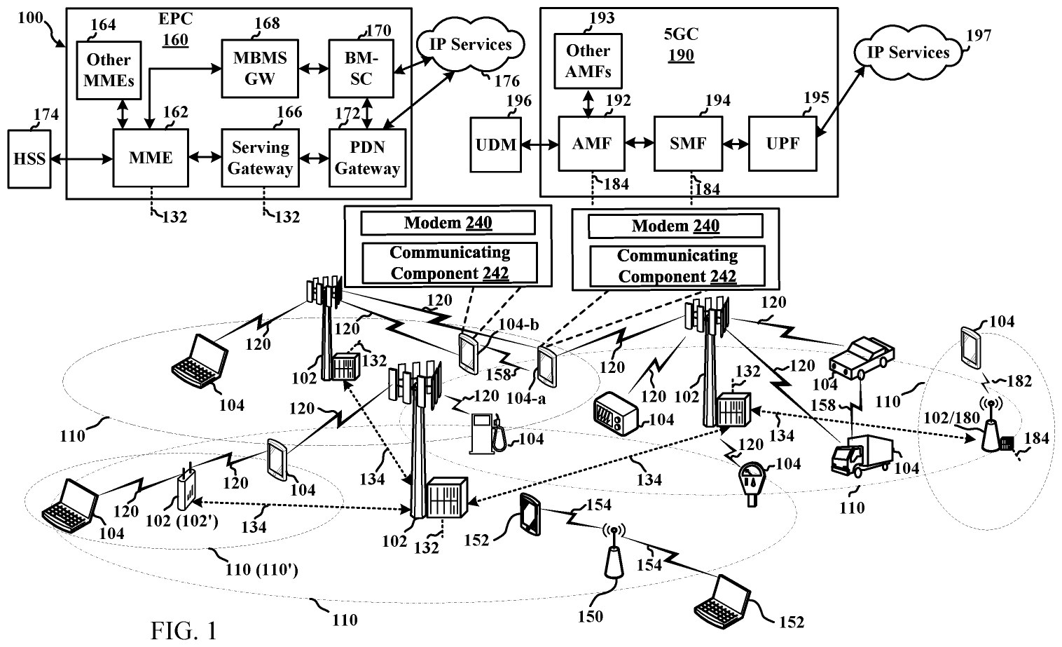

The described features will be presented in more detail below with reference to FIGS. 1-5.

As used in this application, the terms “component,” “module,” “system” and the like are intended to include a computer-related entity, such as but not limited to hardware, software, a combination of hardware and software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and communicating component 242 for initiating data sessions over SL or modifying MCS and/or bandwidth throughout a data session, as described further herein. Though UE 104-a is shown as having the modem 240 and communicating component 242, this is one illustrative example, and substantially any node or type of node may include a modem 240 and communicating component 242 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs (e.g., UE 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network. In addition, in this regard, UEs 104-a, 104-b can use a portion of frequency in the 5 GHz unlicensed frequency spectrum in communicating with the small cell 102′, with other cells, with one another using sidelink communications, etc. The UEs 104-a, 104-b, small cell 102′, other cells, etc. can use other unlicensed frequency spectrums as well, such as a portion of frequency in the 60 GHz unlicensed frequency spectrum.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a positioning system (e.g., satellite, terrestrial), a multimedia device, a video device, a digital audio player (e.g., MP3 player), a camera, a game console, a tablet, a smart device, robots, drones, an industrial/manufacturing device, a wearable device (e.g., a smart watch, smart clothing, smart glasses, virtual reality goggles, a smart wristband, smart jewelry (e.g., a smart ring, a smart bracelet)), a vehicle/a vehicular device, a meter (e.g., parking meter, electric meter, gas meter, water meter, flow meter), a gas pump, a large or small kitchen appliance, a medical/healthcare device, an implant, a sensor/actuator, a display, or any other similar functioning device. Some of the UEs 104 may be referred to as IoT devices (e.g., meters, pumps, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, in a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.), including base station 102 described above and further herein, may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as virtually distributing functionality for at least one unit, which can enable flexibility in network design. The various units of the disaggregated base station, or disaggregated RAN architecture, can be configured for wired or wireless communication with at least one other unit.

In an example, UE 104-a can be a OBU and UE 104-b can be a RSU (or another OBU) that can advertise IP services. Communicating component 242 of UE 104-a can receive messages from communicating component 242 of UE 104-b advertising the IP services (e.g., WSA or WRA). Communicating component 242 of UE 104-a can initiate a data session (e.g., IP session) with UE 104-b using one or more mechanisms described herein. For example, communicating component 242 of UE 104-a can initiate the data session where a signal measurement of a signal from the UE 104-b, such as a signal strength measurement of the WSA or WRA, achieves a threshold. In another example, communicating component 242 of UE 104-a can initiate the data session based on receiving the WSA or WRA, set a MCS and bandwidth based on receiving the WSA or WRA (or based on a signal measurement thereof), and can modify the MCS and bandwidth during the data session as communication quality, signal strength, etc. with the UE 104-b changes

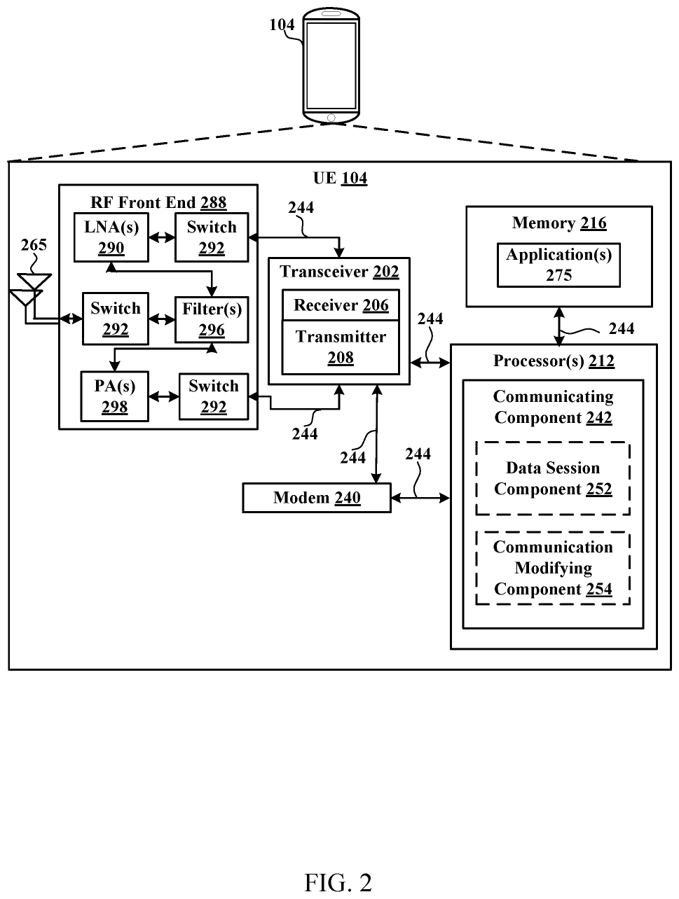

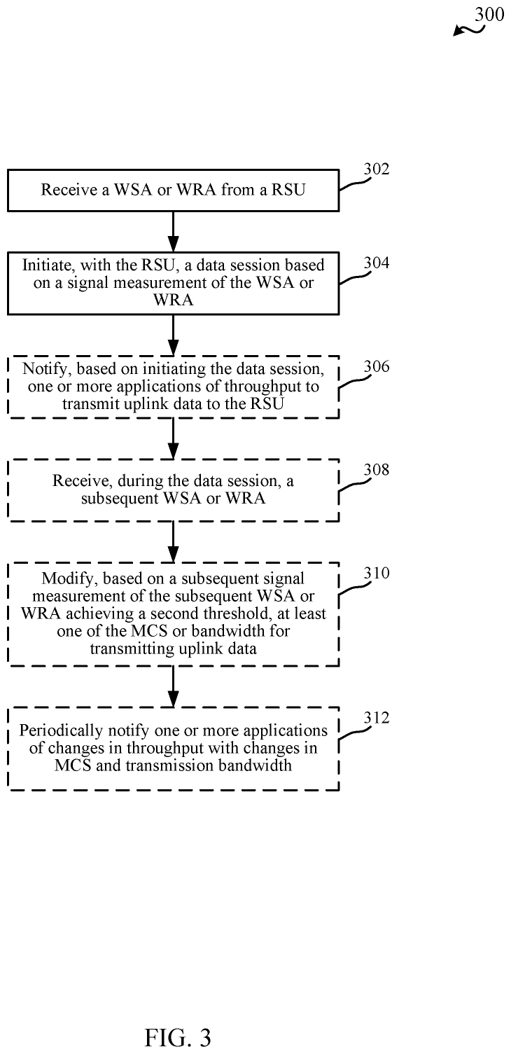

Turning now to FIGS. 2-5, aspects are depicted with reference to one or more components and one or more methods that may perform the actions or operations described herein, where aspects in dashed line may be optional. Although the operations described below in FIG. 3 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 for initiating data sessions over SL or modifying MCS and/or bandwidth throughout a data session, as described herein.

In an aspect, the one or more processors 212 can include one or more modems 240 and/or can be part of one or more modems 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware and/or software executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102 or a SL transmitting UE. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware and/or software executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, receiving wireless communications transmitted by at least one base station 102 or a SL transmitting UE, transmitting wireless communications to at least one base station 102 or a SL receiving UE, etc. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102, one or more other UEs in SL communications, etc. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, communicating component 242 can optionally include a data session component 252 for initiating a data session with another UE (e.g., a RSU) over SL, and/or a communication modifying component 254 for modifying communications for the data session based on a signal measurement, as described herein.

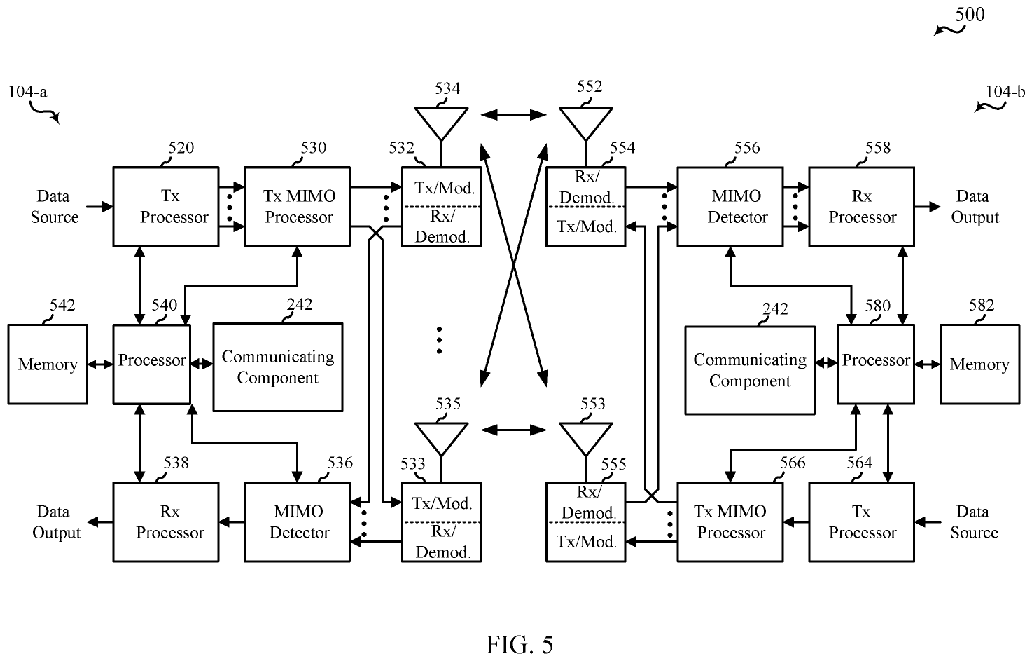

In an aspect, the processor(s) 212 may correspond to one or more of the processors described in connection with the UE in FIG. 5. Similarly, the memory 216 may correspond to the memory described in connection with the UE in FIG. 5.

FIG. 3 illustrates a flow chart of an example of a method 300 for initiating a data session. In an example, a UE (e.g., UE 104-a), which can include a OBU in SL communications, can perform the functions described in method 300 using one or more of the components described in FIGS. 1 and 2.

In method 300, at Block 302, a WSA or WRA can be received from a RSU. In an aspect, data session component 252, e.g., in conjunction with processor(s) 212, memory 216, transceiver 202, communicating component 242, etc., can receive a WSA or WRA (or another message or signal) from the RSU. For example, as described, the RSU can include another UE in the wireless network that can communicate with the OBU using SL communications (e.g., V2X, such as LTE V2X). In an example, data session component 252 can receive the WSA or WRA from the RSU as the OBU approaches a coverage area of the RSU. The WSA or WRA can advertise certain services that the OBU can utilize, such as IPv6 services (e.g., SCMS related services, probe data upload, etc.). In an example, as described, though the OBU may be in range to receive the WSA or WRA, the OBU may not be in range to perform the advertised IPv6 services via the RSU.

In method 300, at Block 304, a data session can be initiated with the RSU based on a signal measurement of the WSA or WRA. In an aspect, data session component 252, e.g., in conjunction with processor(s) 212, memory 216, transceiver 202, communicating component 242, etc., can initiate, with the RSU, the data session, which may include a IP session (e.g., a TCP/IP session), a non-IP bidirectional data session, and/or the like, based on a signal measurement of the WSA or WRA (or other signal from the RSU). For example, data session component 252 can initiate the data session with the RSU when the signal measurement of the WSA or WRA achieves a threshold. For example, the signal measurement can correspond to a received signal strength indicator (RSSI), signal-to-noise ratio (SNR), etc. of the WSA or WRA. Where the RSSI, SNR, etc. achieves the threshold, data session component 252 can initiate the data session via the RSU to receive the IPv6 (or other non-IP bidirectional) services. Where the RSSI, SNR, etc. does not achieve the threshold, data session component 252 can refrain from initiating the data session via the RSU. In an example, data session component 252 can continue to receive and measure the WSA or WRA from the RSU, and can initiate the data session when (or if) the signal measurement achieves the threshold.

In one example, the threshold can be based on a signal measurement delta and/or other parameters. For example, the threshold can include a signal measurement (e.g., SNR) delta between an SNR to decode a maximum available MCS (max MCS) and a SNR to decode the received WSA or WRA MCS (received MCS). The threshold may also include a bandwidth adjustment, which may be computed based on a maximum number of RBs (maxRB) and the number of received RBs of the received WSA or WRA (recv WSA numRB). For example, data session component 252 can compute the bandwidth adjustment as 10 log 10(maxRB)−10 log 10(recv WSA numRB). In yet another example, the threshold may include margin of a number of dB (e.g., 1 to 2 dB). In a specific example, data session component 252 can compare the SNR of the received WSA or WRA to the SNR delta (max MCS, received MCS)+bandwidth adjustment+margin, and can initiate the data session of the SNR of the received WSA or WRA is greater than the SNR delta (max MCS, received MCS)+bandwidth adjustment+margin.

In one example, data session component 252 can initiate the data session by transmitting the request over a data channel (e.g., PSSCH). For example, data session component 252 can transmit the request over the PSSCH using the lowered MCS. In one example, data session component 252 can indicate the MCS in a control channel communication (e.g., over PSCCH).

In method 300, optionally at Block 306, one or more applications can be notified, based on initiating the data session, of throughput to transmit uplink data to the RSU. In an aspect, data session component 252, e.g., in conjunction with processor(s) 212, memory 216, transceiver 202, communicating component 242, etc., can notify, based on initiating the data session, one or more applications executing on the UE 104-a (e.g., applications 275) of throughput to transmit uplink data to the RSU (e.g., over the SL channel). For example, the modem 240 can give the applications 275 the indication on when uplink unicast data can start. For example, the notification can indicate instantaneous throughput for transmitting uplink data for each traffic class. In this example, the applications 275 can track changing radio conditions based on receiving the notification (and/or other notifications over a period of time) and can accordingly determine how much uplink data to transmit to the RSU.

Though the terms uplink and downlink communications are used herein, the communications can occur over a SL channel, and the uplink communications can be from OBU to RSU, and the downlink communications can be from RSU to OBU. In the above examples, the spectrum can be effectively used to transfer data when enough spectrum is usable based on RF conditions between the OBU and RSU, and the data session can have a greater chance of succeeding than where the session is established based only on receiving the WSA or WRA.

In another example, the OBU can initiate the data session with the RSU once the WSA or WRA is received (e.g., where the WSA or WRA is of a sufficient signal measurement to be successfully received and processed). In this example, data session component 252 can initiate the data session with the RSU based on the signal measurement of the WSA or WRA including selecting, based on the signal measurement, a MCS for requesting the data session. For example, data session component 252 can initially select a lower MCS for requesting the data session, and communication modifying component 254 can modify the MCS as RF conditions with the RSU improve (e.g., based on the signal measurement of subsequent WSA or WRA signals).

For example, in method 300, optionally at Block 308, a subsequent WSA or WRA can be received during the data session. In an aspect, data session component 252, e.g., in conjunction with processor(s) 212, memory 216, transceiver 202, communicating component 242, etc., can receive, from the RSU, the subsequent WSA or WRA during the data session established with the RSU.

In method 300, optionally at Block 310, at least one of the MCS or bandwidth for transmitting uplink data can be modified based on a subsequent signal measurement of the subsequent WSA or WRA achieving a second threshold. In an aspect, communication modifying component 254, e.g., in conjunction with processor(s) 212, memory 216, transceiver 202, communicating component 242, etc., can modify, based on the subsequent signal measurement (e.g., RSSI, SNR, etc.) of the subsequent WSA or WRA achieving a second threshold, at least one of the MCS or bandwidth for transmitting uplink data (e.g., in the data session). For example, communication modifying component 254 can select a MCS for higher throughput as the subsequent signal measurement improves. In one example, the MCS or bandwidth can be indicated in a configuration as associated with the subsequent signal measurement (or a range of signal measurements). In an example, communication modifying component 254 can use the modified MCS or bandwidth for transmitting uplink data over a sidelink channel (e.g., PSSCH).

For example, using the adaptive MCS, the OBU can initiate the IP session, select an uplink MCS and bandwidth based on SNR of received WSA or WRA, and select MCS, RB combination to maximize data throughput. As the SNR of received WSA improves, the OBU can revise the MCS and RB selection. For example, where the bandwidth adjusted SNR of received WSA=X dB, the OBU can select MCS, RB combination that meets the bandwidth adjusted SNR of X dB, but maximizes the number of bits transmitted. For example, data session component 252 can select MCS 7 with 96 RB over MCS 11 and 48 RB for initiating the data session with the RSU, and then may select MCS 11 and 48 RB once the signal measurement of the WSA or WRA received from the RSU improves. In this example, the OBU can start the session after receiving the WSA or WRA and can have longer time to finish uploading the data. In this example, the modem 240 may not need to notify the applications 275 to transmit uplink data.

In method 300, optionally at Block 312, one or more applications can be periodically notified of changes in throughput with changes in MCS and transmission bandwidth. In an aspect, data session component 252, e.g., in conjunction with processor(s) 212, memory 216, transceiver 202, communicating component 242, etc., can periodically notify one or more applications executing on the UE 104-a (e.g., applications 275) of changes in throughput with changes in MCS and transmission bandwidth. For example, as MCS and transmission bandwidth changes are detected (e.g., at Block 310), which may be for each traffic class, the one or more applications 275 can be periodically notified of resulting changes in available instantaneous throughput (e.g., for a given traffic class), which may allow the one or more application 275 to increase uplink data being sent to the RSU. For example, data session component 252 can periodically notify the one or more applications as changes are detected, based on a periodic interval where a latest change, or aggregate of changes, can be provided to the one or more applications 275, etc. For example, data session component 252 can periodically notify the one or more applications on the OBU by using a callback function or other mechanism.

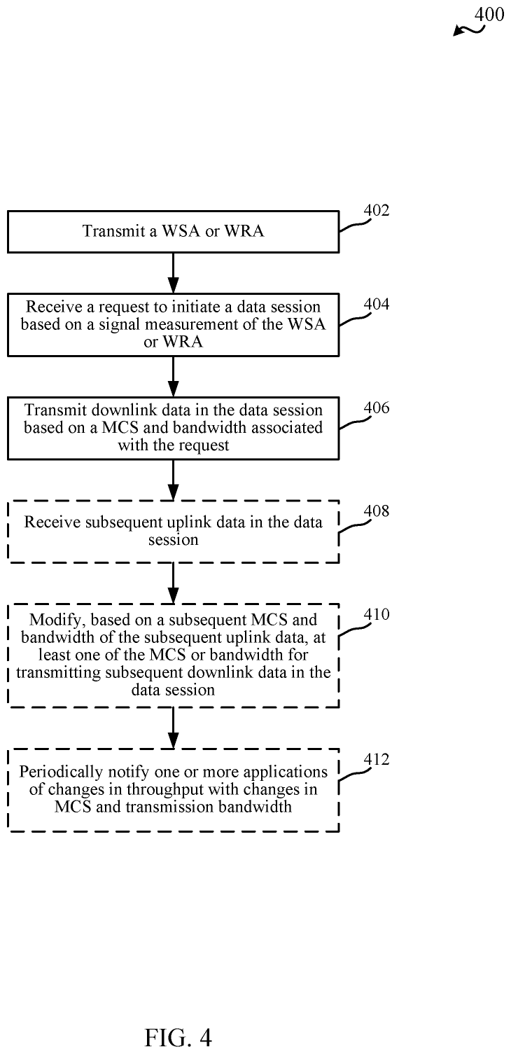

FIG. 4 illustrates a flow chart of an example of a method 400 for communicating with a UE in SL based on changing MCS or bandwidth. In an example, a UE (e.g., UE 104-b), which can include a RSU in SL communications, can perform the functions described in method 400 using one or more of the components described in FIGS. 1 and 2.

In method 400, at Block 402, a WSA or WRA can be transmitted. In an aspect, data session component 252, e.g., in conjunction with processor(s) 212, memory 216, transceiver 202, communicating component 242, etc., can transmit the WSA or WRA. For example, as described, the RSU can transmit the WSA or WRA to advertise certain services that an OBU can utilize, such as IPv6 services (e.g., SCMS related services, probe data upload, etc.), or other IP-based or non-IP bidirectional services.

In method 400, at Block 404, a request to initiate a data session based on a signal measurement of the WSA or WRA can be received. In an aspect, data session component 252, e.g., in conjunction with processor(s) 212, memory 216, transceiver 202, communicating component 242, etc., can receive the request to initiate the data session, which may include a IP session (e.g., a TCP/IP session), a non-IP bidirectional data session, and/or the like, based on the signal measurement of the WSA or WRA. For example, data session component 252 can receive the request from an OBU that is within range to establish the data session. In an example, the OBU can transmit the request with a MCS or bandwidth selected for lower throughput and more reliable communication, as described (e.g., MCS 7 with 96 RB in the example above).

In method 400, at Block 406, downlink data can be transmitted in the data session based on a MCS and bandwidth associated with the request. In an aspect, data session component 252, e.g., in conjunction with processor(s) 212, memory 216, transceiver 202, communicating component 242, etc., can transmit downlink data in the data session based on the MCS and bandwidth associated with the request. For example, data session component 252 can determine the MCS and bandwidth of the request (e.g., as indicated in or determined based on the request) and can use the same (or similar) MCS and bandwidth (or amount of bandwidth—e.g., number of RBs) to transmit the downlink data to the OBU.

In method 400, optionally at Block 408, subsequent uplink data can be received in the data session. In an aspect, data session component 252, e.g., in conjunction with processor(s) 212, memory 216, transceiver 202, communicating component 242, etc., can receive (e.g., from the OBU) subsequent uplink data in the data session. For example, data session component 252 can receive the subsequent uplink data over a data channel (e.g., PSSCH). As described, for example, the OBU can adjust the MCS and bandwidth of uplink data as the WSA or WRA signal measurements improve at the UE. Thus, data session component 252 can determine the MCS and bandwidth for each uplink data transmission from the OBU, in one example.

In method 400, optionally at Block 410, at least one of the MCS or bandwidth for transmitting subsequent downlink data in the data session can be modified based on a subsequent MCS and bandwidth of the subsequent uplink data. In an aspect, communication modifying component 254, e.g., in conjunction with processor(s) 212, memory 216, transceiver 202, communicating component 242, etc., can modify, based on the subsequent MCS and bandwidth of the subsequent uplink data (e.g., MCS and bandwidth used to transmit the subsequent uplink data transmission from the OBU), at least one of the MCS or bandwidth used for transmitting subsequent downlink data in the data session. For example, communication modifying component 254 can modify the MCS and bandwidth based on that observed from the subsequent uplink data, or indicated in control information for the subsequent uplink data (e.g., over PSCCH), etc.

In method 400, optionally at Block 412, one or more applications can be periodically notified of changes in throughput with changes in MCS and transmission bandwidth. In an aspect, data session component 252, e.g., in conjunction with processor(s) 212, memory 216, transceiver 202, communicating component 242, etc., can periodically notify one or more applications executing on an OBU (e.g., applications 275) of changes in throughput with changes in MCS and transmission bandwidth. For example, as MCS and transmission bandwidth changes are detected (e.g., at Block 410), which may be for each traffic class, data session component 252 can periodically notify the one or more applications 275 of the RSU of resulting changes in available instantaneous throughput (e.g., for a given traffic class), which may allow the one or more applications 275 to increase downlink data being sent to the OBU. For example, data session component 252 can periodically notify the one or more applications as changes are detected, based on a periodic interval where a latest change, or aggregate of changes, can be provided to the one or more applications 275, etc. For example, data session component 252 can periodically notify the one or more applications on the RSU by using a callback function or other mechanism.

FIG. 5 is a block diagram of a MIMO communication system 500 including UEs 104-a, 104-b. The MIMO communication system 500 may illustrate aspects of the wireless communication access network 100 described with reference to FIG. 1. The UE 104-a may be an example of aspects of the UE 104 described with reference to FIGS. 1 and 3. The UE 104-a may be equipped with antennas 534 and 535, and the UE 104-b may be equipped with antennas 552 and 553. In the MIMO communication system 500, the UEs 104-a, 104-b may be able to send data over multiple communication links at the same time. Each communication link may be called a “layer” and the “rank” of the communication link may indicate the number of layers used for communication. For example, in a 2×2 MIMO communication system where UE 104-a transmits two “layers,” the rank of the communication link between the UE 104-a and the UE 104-b is two.

At the UE 104-a, a transmit (Tx) processor 520 may receive data from a data source. The transmit processor 520 may process the data. The transmit processor 520 may also generate control symbols or reference symbols. A transmit MIMO processor 530 may perform spatial processing (e.g., precoding) on data symbols, control symbols, or reference symbols, if applicable, and may provide output symbol streams to the transmit modulator/demodulators 532 and 533. Each modulator/demodulator 532 through 533 may process a respective output symbol stream (e.g., for OFDM, etc.) to obtain an output sample stream. Each modulator/demodulator 532 through 533 may further process (e.g., convert to analog, amplify, filter, and upconvert) the output sample stream to obtain a DL signal. In one example, DL signals from modulator/demodulators 532 and 533 may be transmitted via the antennas 534 and 535, respectively.

The UE 104-b may be an example of aspects of the UEs 104 described with reference to FIGS. 1 and 3. At the UE 104-b, the UE antennas 552 and 553 may receive the signals from the UE 104-a (e.g., over a sidelink) and may provide the received signals to the modulator/demodulators 554 and 555, respectively. Each modulator/demodulator 554 through 555 may condition (e.g., filter, amplify, downconvert, and digitize) a respective received signal to obtain input samples. Each modulator/demodulator 554 through 555 may further process the input samples (e.g., for OFDM, etc.) to obtain received symbols. A MIMO detector 556 may obtain received symbols from the modulator/demodulators 554 and 555, perform MIMO detection on the received symbols, if applicable, and provide detected symbols. A receive (Rx) processor 558 may process (e.g., demodulate, deinterleave, and decode) the detected symbols, providing decoded data for the UE 104-b to a data output, and provide decoded control information to a processor 580, or memory 582.

At the UE 104-b, a transmit processor 564 may receive and process data from a data source. The transmit processor 564 may also generate reference symbols for a reference signal. The symbols from the transmit processor 564 may be precoded by a transmit MIMO processor 566 if applicable, further processed by the modulator/demodulators 554 and 555 (e.g., for SC-FDMA, etc.), and be transmitted to the UE 104-a in accordance with the communication parameters received from the UE 104-a. At the UE 104-a, the signals from the UE 104-b may be received by the antennas 534 and 535, processed by the modulator/demodulators 532 and 533, detected by a MIMO detector 536 if applicable, and further processed by a receive processor 538. The receive processor 538 may provide decoded data to a data output and to the processor 540 or memory 542.

The processor 540 and/or 580 may in some cases execute stored instructions to instantiate a communicating component 242 (see e.g., FIGS. 1 and 3).

The components of the UEs 104-a, 104-b may, individually or collectively, be implemented with one or more ASICs adapted to perform some or all of the applicable functions in hardware. Each of the noted modules may be a means for performing one or more functions related to operation of the MIMO communication system 500. Similarly, the components of the UE 104-a may, individually or collectively, be implemented with one or more ASICs adapted to perform some or all of the applicable functions in hardware. Each of the noted components may be a means for performing one or more functions related to operation of the MIMO communication system 500.

The following aspects are illustrative only and aspects thereof may be combined with aspects of other embodiments or teaching described herein, without limitation.

Aspect 1 is a method for wireless communication including receiving a WSA from a RSU, and initiating, with the RSU, a data session based on a signal measurement of the WSA.

In Aspect 2, the method of Aspect 1 includes where initiating the data session is based on the signal measurement achieving a threshold.

In Aspect 3, the method of Aspect 2 includes where the threshold relates to a difference in the signal measurement for decoding a signal having a maximum MCS and a MCS for decoding the WSA.

In Aspect 4, the method of Aspect 3 includes where the threshold also includes a bandwidth adjustment corresponding to a maximum number of resource blocks and a number of resource blocks of the WSA.

In Aspect 5, the method of Aspect 4 includes where the threshold also includes a margin of a fixed number of decibels.

In Aspect 6, the method of any of Aspects 1 to 5 includes notifying, based on initiating the data session, one or more applications to transmit uplink data to the RSU.

In Aspect 7, the method of Aspect 6 includes where notifying the one or more applications includes notifying of an available throughput as a result of initiating the data session with the RSU.

In Aspect 8, the method of any of Aspects 1 to 7 includes where initiating the data session includes selecting, based on the signal measurement achieving a threshold, a MCS and bandwidth for initiating the data session.

In Aspect 9, the method of Aspect 8 includes receiving, during the data session, a subsequent WSA, and modifying, based on a subsequent signal measurement of the subsequent WSA achieving a second threshold, at least one of the MCS or the bandwidth for transmitting uplink data in the data session.

In Aspect 10, the method of Aspect 9 includes notifying, based on modifying at least one of the MCS or the bandwidth, one or more applications of an available throughput as a result of modifying at least one of the MCS or the bandwidth.

In Aspect 11, the method of any of Aspects 8 to 10 includes where selecting the MCS and bandwidth includes selecting an available MCS and resource block combination that maximizes data throughput and is indicated for the second threshold.

In Aspect 12, the method of any of Aspects 1 to 11 includes where the data session is a TCP/IP session.

Aspect 13 is a method for wireless communication including transmitting a WSA, receiving a request to initiate a data session based on a signal measurement of the WSA, and transmitting downlink data in the data session based on a MCS and bandwidth of the request.

In Aspect 14, the method of Aspect 13 includes receiving subsequent uplink data in the data session, and modifying, based on a subsequent MCS and bandwidth of the subsequent uplink data, at least one of the MCS or the bandwidth for transmitting subsequent downlink data in the data session.

In Aspect 15, the method of Aspect 14 includes notifying, based on modifying at least one of the MCS or the bandwidth, one or more applications of an available throughput as a result of modifying at least one of the MCS or the bandwidth.

In Aspect 16, the apparatus of any of Aspects 13 to 15 includes where the data session is a TCP/IP session.

Aspect 17 is an apparatus for wireless communication including a transceiver, a memory configured to store instructions, and one or more processors communicatively coupled with the memory and the transceiver, where the one or more processors are configured to execute the instructions to cause the apparatus to perform one or more of the methods of any of Aspects 1 to 16.

Aspect 18 is an apparatus for wireless communication including means for performing one or more of the methods of any of Aspects 1 to 16.

Aspect 19 is a computer-readable medium including code executable by one or more processors for wireless communications, the code including code for performing one or more of the methods of any of Aspects 1 to 16.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, hardwiring, or combinations of any of these. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. Also, as used herein, including in the claims, “or” as used in a list of items prefaced by “at least one of” indicates a disjunctive list such that, for example, a list of “at least one of A, B, or C” means A or B or C or AB or AC or BC or ABC (A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the transceiver and the memory, wherein the one or more processors are configured to:
receive a wave service announcement (WSA) from a roadside unit (RSU); and
initiate, with the RSU, a data session based on a signal measurement of the WSA.

2. The apparatus of claim 1, wherein the one or more processors are configured to initiate the data session based on the signal measurement achieving a threshold.

3. The apparatus of claim 2, wherein the threshold relates to a difference in the signal measurement for decoding a signal having a maximum modulation and coding scheme (MCS) and a MCS for decoding the WSA.

4. The apparatus of claim 3, wherein the threshold also includes a bandwidth adjustment corresponding to a maximum number of resource blocks and a number of resource blocks of the WSA.

5. The apparatus of claim 4, wherein the threshold also includes a margin of a fixed number of decibels.

6. The apparatus of claim 1, wherein the one or more processors are further configured to notify, based on initiating the data session, one or more applications to transmit uplink data to the RSU.

7. The apparatus of claim 6, wherein the one or more processors are configured to notify the one or more applications of an available throughput as a result of initiating the data session with the RSU.

8. The apparatus of claim 1, wherein the one or more processors are configured to initiate the data session at least in part by selecting, based on the signal measurement achieving a threshold, a modulation and coding scheme (MCS) and bandwidth for initiating the data session.

9. The apparatus of claim 8, wherein the one or more processors are further configured to:
receive, during the data session, a subsequent WSA; and
modify, based on a subsequent signal measurement of the subsequent WSA achieving a second threshold, at least one of the MCS or the bandwidth for transmitting uplink data in the data session.

10. The apparatus of claim 9, wherein the one or more processors are further configured to notify, based on modifying at least one of the MCS or the bandwidth, one or more applications of an available throughput as a result of modifying at least one of the MCS or the bandwidth.

11. The apparatus of claim 8, wherein the one or more processors are configured to select the MCS and bandwidth at least in part by selecting an available MCS and resource block combination that maximizes data throughput and is indicated for the second threshold.

12. The apparatus of claim 1, wherein the data session is a transmission control protocol/internet protocol (TCP/IP) session.

13. A method for wireless communication, comprising:
receiving a wave service announcement (WSA) from a roadside unit (RSU); and
initiating, with the RSU, a data session based on a signal measurement of the WSA.

14. The method of claim 13, wherein initiating the data session is based on the signal measurement achieving a threshold.

15. The method of claim 14, wherein the threshold relates to a difference in the signal measurement for decoding a signal having a maximum modulation and coding scheme (MCS) and a MCS for decoding the WSA.

16. The method of claim 15, wherein the threshold also includes a bandwidth adjustment corresponding to a maximum number of resource blocks and a number of resource blocks of the WSA.

17. The method of claim 16, wherein the threshold also includes a margin of a fixed number of decibels.

18. The method of claim 10, further comprising notifying, based on initiating the data session, one or more applications to transmit uplink data to the RSU.

19. The method of claim 18, wherein notifying the one or more applications includes notifying of an available throughput as a result of initiating the data session with the RSU.

20. The method of claim 13, wherein initiating the data session includes selecting, based on the signal measurement achieving a threshold, a modulation and coding scheme (MCS) and bandwidth for initiating the data session.

21. The method of claim 20, further comprising:
receiving, during the data session, a subsequent WSA; and
modifying, based on a subsequent signal measurement of the subsequent WSA achieving a second threshold, at least one of the MCS or the bandwidth for transmitting uplink data in the data session.

22. The method of claim 21, further comprising notifying, based on modifying at least one of the MCS or the bandwidth, one or more applications of an available throughput as a result of modifying at least one of the MCS or the bandwidth.

23. The method of claim 20, wherein selecting the MCS and bandwidth includes selecting an available MCS and resource block combination that maximizes data throughput and is indicated for the second threshold.

24. An apparatus for wireless communication, comprising:
a transceiver;
a memory configured to store instructions; and
one or more processors communicatively coupled with the transceiver and the memory, wherein the one or more processors are configured to:
transmit a wave service announcement (WSA);
receive a request to initiate a data session based on a signal measurement of the WSA; and
transmit downlink data in the data session based on a modulation and coding scheme (MCS) and bandwidth associated with the request.

25. The apparatus of claim 19, wherein the one or more processors are further configured to:
receive subsequent uplink data in the data session; and
modify, based on a subsequent MCS and bandwidth of the subsequent uplink data, at least one of the MCS or the bandwidth for transmitting subsequent downlink data in the data session.

26. The apparatus of claim 25, wherein the one or more processors are further configured to notify, based on modifying at least one of the MCS or the bandwidth, one or more applications of an available throughput as a result of modifying at least one of the MCS or the bandwidth.

27. The apparatus of claim 24, wherein the data session is a transmission control protocol/internet protocol (TCP/IP) session.

28. A method for wireless communication, comprising:
transmitting a wave service announcement (WSA);
receiving a request to initiate a data session based on a signal measurement of the WSA; and
transmitting downlink data in the data session based on a modulation and coding scheme (MCS) and bandwidth associated with the request.

29. The method of claim 28, further comprising:
receiving subsequent uplink data in the data session; and
modifying, based on a subsequent MCS and bandwidth of the subsequent uplink data, at least one of the MCS or the bandwidth for transmitting subsequent downlink data in the data session.

30. The method of claim 29, further comprising notifying, based on modifying at least one of the MCS or the bandwidth, one or more applications of an available throughput as a result of modifying at least one of the MCS or the bandwidth.
